(19) United States
(12) Patent Application Publication
(10) Pub. No.: US 2026/0357012 A1
(43) Pub. Date: Nov. 12, 2026

(54) COMPOSITION, POLYIMIDE FILM MANUFACTURED THEREFROM, ELECTRONIC DEVICE INCLUDING THE POLYIMIDE FILM AND METHOD OF PREPARING POLYIMIDE FILM

(71) Applicants: Samsung Display Co., Ltd., Yongin-si (KR); Dongjin Semichem Co., Ltd, Incheon (KR)

(72) Inventors: Junho SIM, Yongin-si (KR); Youngjun Kim, Yongin-si (KR); Heekyun Shin, Yongin-si (KR); Yonghoon Yang, Yongin-si (KR); Joonbum Lee, Yongin-si (KR); Dongmin Kim, Hwaseong-si (KR); Youngho Seo, Hwaseong-si (KR)

(73) Assignees: Samsung Display Co., Ltd., Yongin-si (KR); Dongjin Semichem Co., Ltd, Incheon (KR)

(21) Appl. No.: 19/649,765

(22) Filed: Apr. 16, 2026

(30) Foreign Application Priority Data
May 2, 2025 (KR) 10-2025-0058482

(51) Int. Cl. C08G 73/10; C08J 5/18

(52) U.S. Cl. CPC C08G 73/1071; C08G 73/1032; C08J 5/18; C08J 2379/08

(57) ABSTRACT

A composition, a polyimide film manufactured from the composition, an electronic device including the polyimide film, and a method of preparing the polyimide film are provided. The composition includes (i) a polymerizable component including a diamine compound-containing first component and a tetracarboxylic dianhydride-containing second component and (ii) a solvent, wherein the solvent includes a mixed solvent including two or more solvents, and the mixed solvent includes an amide-based solvent and a sulfone-based solvent.

### CROSS-REFERENCE TO RELATED APPLICATION

This application is based on and claims priority under 35 U.S.C. § 119 to Korean Patent Application No. 10-2025-0058482, filed on May 2, 2025, in the Korean Intellectual Property Office, the disclosure of which is incorporated by reference herein in its entirety.

### BACKGROUND

### 1. Field

One or more embodiments relate to a composition, a polyimide film manufactured from the composition, an electronic device including the polyimide film, and a method of preparing the polyimide film.

### 2. Description of Related Art

Polyimide films used as substrates of light-emitting devices are desired to have excellent optical properties, surface characteristics, thermal stability, and the like.

Recently, development of flexible, foldable, and/or rollable products and/or devices has been actively progressing, and in particular, there is a need to develop solvents replacing environmentally regulated solvents in the manufacture of polyimide films.

### SUMMARY

One or more embodiments include a composition, a polyimide film manufactured from the composition, an electronic device including the polyimide film, and a method of preparing the polyimide film.

Additional aspects will be set forth in part in the description which follows and, in part, will be apparent from the description, or may be learned by practice of the embodiments of the disclosure presented herein.

According to one or more embodiments, a composition includes a polymerizable component including a diamine compound-containing first component and a tetracarboxylic dianhydride-containing second component, and a solvent, wherein the solvent includes a mixed solvent including two or more solvents, and the mixed solvent includes an amide-based solvent and a sulfone-based solvent.

According to one or more embodiments, a polyimide film is manufactured from the composition.

According to one or more embodiments, an electronic apparatus includes the polyimide film.

According to one or more embodiments, an electronic device includes the polyimide film.

According to one or more embodiments, a method of preparing a polyimide film includes applying a composition to a carrier substrate, and forming a polyimide film via imidization by heating the composition, wherein the composition includes a polymerizable component including a diamine compound-containing first component, and a tetracarboxylic dianhydride-containing second component, and a solvent, wherein the solvent includes a mixed solvent including two or more solvents, and the mixed solvent includes an amide-based solvent and a sulfone-based solvent.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 is a diagram schematically illustrating an electronic apparatus according to an embodiment;

FIG. 2 is a diagram schematically illustrating an electronic apparatus according to another embodiment;

FIG. 3 is a block diagram of an electronic device according to an embodiment;

FIG. 4 shows schematic diagrams of electronic devices according to various embodiments;

FIG. 5 is a perspective view schematically illustrating an electronic device including a polyimide film according to an embodiment;

FIG. 6 is a diagram schematically illustrating aspects of the exterior of a vehicle as electronic devices including a polyimide film according to an embodiment; and

FIGS. 7A to 7C are diagrams schematically illustrating the interior of vehicles according to various embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below by referring to the figures to explain aspects of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

As the disclosure below allows for various changes and numerous embodiments, particular embodiments will be illustrated in the drawings and described in detail in the written description. Effects and features of the disclosure and a method of achieving the effects and features will be apparent by referring to embodiments described below in connection with the accompanying drawings. However, the disclosure is not restricted by these embodiments but can be implemented in many different forms.

Hereinafter, embodiments will be described in detail with reference to the accompanying drawings. In the drawings, like reference numerals denote like elements or components having substantially same functions, and duplicate descriptions will be omitted.

In the following embodiments, terms “first,” “second,” etc. are used to distinguish one component from other components and, therefore, the components are not limited by the terms.

An expression used in the singular encompasses the expression of the plural unless it has a clearly different meaning in the context.

In the following embodiments, it is to be understood that the terms “include” or “have” are intended to indicate the existence of elements disclosed in the specification, and are not intended to preclude the possibility that one or more other elements may exist or may be added.

As used herein, when one element such as a layer, film, region, or plate is referred to as being “on” another element, it may be “directly on” the other element, or intervening elements may also be present therebetween. In addition, sizes of elements in the drawings may be exaggerated or reduced for convenience of explanation. For example, since sizes and thicknesses of components in the drawings are arbitrarily illustrated for convenience of explanation, the following embodiments are not limited thereto.

### [Composition]

According to an embodiment, a composition includes
a polymerizable component including a diamine compound-containing first component and a tetracarboxylic dianhydride-containing second component, and
a solvent,
wherein the solvent includes a mixed solvent including two or more solvents, and
the mixed solvent includes an amide-based solvent and a sulfone-based solvent.

According to an embodiment, the amide-based solvent may include N,N-dimethylpropionamide, 3-methoxy-N,N-dimethylpropionamide, N-methylpropionamide, N,N-diethylformamide, or any combination thereof.

According to another embodiment, the amide-based solvent may be N,N-dimethylpropionamide.

According to an embodiment, the amide-based solvent may be a compound represented by Formula 1 below:

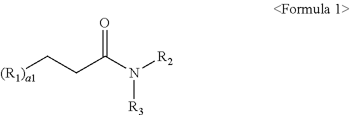

wherein in Formula 1,
R₁ to R₃ are each independently hydrogen, deuterium, —F, —Cl, —Br, —I, a hydroxyl group, a cyano group, a nitro group, a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₁-C₆₀ alkylthio group unsubstituted or substituted with at least one R₁₀ₐ, a C₃-C₆₀ carbocyclic group unsubstituted or substituted with at least one R₁₀ₐ, a C₁-C₆₀ heterocyclic group unsubstituted or substituted with at least one R₁₀ₐ, a C₀-C₆₀ aryloxy group unsubstituted or substituted with at least one R₁₀ₐ, a C₆-C₆₀ arylthio group unsubstituted or substituted with at least one R₁₀ₐ, —C(Q₁)(Q₂)(Q₃), —Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂),
a1 is an integer from 1 to 20,
wherein R₁₀ₐ is:
deuterium, —F, —Cl, —Br, —I, a hydroxyl group, a cyano group, or a nitro group;
a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or any combination thereof;
a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, or a C₂-C₆₀ heteroarylalkyl group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or
—Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂);
wherein Q₁ to Q₃, Q₁₁ to Q₁₃, Q₂₁ to Q₂₃, and Q₃₁ to Q₃₃ are each independently: hydrogen; deuterium; —F; —Cl; —Br; —I; a hydroxyl group; a cyano group; a nitro group; a C₁-C₆₀ alkyl group; a C₂-C₆₀ alkenyl group; a C₂-C₆₀ alkynyl group; a C₁-C₆₀ alkoxy group; a C₃-C₆₀ carbocyclic group or a C₁-C₆₀ heterocyclic group, each unsubstituted or substituted with deuterium, —F, a cyano group, a C₁-C₆₀ alkyl group, a C₁-C₆₀ alkoxy group, a phenyl group, a biphenyl group, or any combination thereof; a C₇-C₆₀ arylalkyl group; or a C₂-C₆₀ heteroarylalkyl group.

According to an embodiment, in Formula 1,
R₁ to R₃ may be each independently selected from hydrogen, deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, or a C₁-C₆₀ alkoxy group;
a C₁-C₆₀ alkyl group, a C₁-C₆₀ cycloalkyl group, a C₁-C₆₀ heterocycloalkyl group, a phenyl group, a biphenyl group, a terphenyl group, a tetraphenyl group, a pentaphenyl group, a naphthyl group, an anthracenyl group, a phenanthrenyl group, a phenalenyl group, a triphenylenyl group, a pyrenyl group, a chrysenyl group, a pyrrolyl group, a furanyl group, a thiophenyl group, an imidazolyl group, a pyrazolyl group, a thiazolyl group, an isothiazolyl group, an oxazolyl group, an isoxazolyl group, a pyridinyl group, a pyrazinyl group, a pyrimidinyl group, a pyridazinyl group, an isoindolyl group, an indolyl group, an indazolyl group, a purinyl group, a quinolinyl group, an isoquinolinyl group, a benzoquinolinyl group, a quinoxalinyl group, a quinazolinyl group, a cinolinyl group, a phenanthrolinyl group, a benzimidazolyl group, a benzofuranyl group, a dibenzofuranyl group, a benzothiophenyl group, a dibenzothiophenyl group, a benzoisothiazolyl group, a benzoxazolyl group, a benzoisoxazolyl group, a triazolyl group, a tetrazolyl group, an oxadiazolyl group, a triazinyl group, a dibenzofuranyl group, a dibenzothiophenyl group, a carbazolyl group, a benzocarbazolyl group, a fluorenyl group, a benzoisothiazolyl group, a benzoxazolyl group, a benzoisoxazolyl group, a phenoxazinyl group, an acridinyl group, and a xanthenyl group, each unsubstituted or substituted with deuterium, —F, —Cl, —Br, —I, a hydroxyl group, a cyano group, a nitro group, a C₁-C₆₀ alkyl group, a C₁-C₆₀ cycloalkyl group, a C₂-C₆₀ alkenyl group, a C₂-C₆₀ alkynyl group, a C₁-C₆₀ alkoxy group, a phenyl group, a biphenyl group, a terphenyl group, or any combination thereof; and
—Si(Q₁)(Q₂)(Q₃), —Ge(Q₁)(Q₂)(Q₃), and —N(Q₁)(Q₂).

According to an embodiment, in Formula 1,
R₁ may be hydrogen, deuterium, a C₁-C₆₀ alkyl group unsubstituted or substituted with at least one R₁₀ₐ, or a C₁-C₆₀ alkoxy group unsubstituted or substituted with at least one R₁₀ₐ, and
R₂ and R₃ may be each independently hydrogen, deuterium, or a C₁-C₆₀ alkyl group unsubstituted or substituted with at least one R₁₀ₐ.

According to another embodiment, R₁ may be hydrogen, deuterium, a methyl group, an ethyl group, a propyl group, a butyl group, a methoxy group, or an ethoxy group, and
R₂ and R₃ may be each independently hydrogen, deuterium, a methyl group, an ethyl group, a propyl group, or a butyl group.

According to an embodiment, the sulfone-based solvent may include tetramethylene sulfone, diphenyl sulfone, ethyl isopropyl sulfone, or any combination thereof.

According to another embodiment, the sulfone-based solvent may be tetramethylene sulfone (sulfolane).

According to an embodiment, a boiling point of the sulfone-based solvent may be 200 °C or above. For example, the boiling point of the sulfone-based solvent may be about 200 °C to about 500 °C, about 200 °C to about 450 °C, or about 200 °C to about 400 °C (the term “about” means ±5% for purposes of this specification).

Due to the boiling point being within the temperature ranges given above, the stability of the sulfone-based solvent may be maintained during high-temperature reactions in a polyimide film manufacturing process and a TFT manufacturing process.

According to an embodiment, the amide-based solvent and the sulfone-based solvent may be included in a weight ratio of about 1:99 to about 99:1. For example, the amide-based solvent and the sulfone-based solvent may be included in a weight ratio of about 1:99 to about 99:1, about 1:95 to about 95:1, about 1:90 to about 90:1, about 1:70 to about 70:1, about 1:50 to about 50:1, about 1:30 to about 30:1, about 1:15 to about 15:1, about 1:10 to about 10:1, about 1:8 to about 8:1, about 1:5 to about 5:1, about 1:4 to about 4:1, about 1:3 to about 3:1, about 1:2 to about 2:1, or 1:1. According to an embodiment, the composition may further comprise a polymerization product of the polymerizable component.

According to an embodiment, the polymerizable component may be included in a weight ratio of about 5 parts by weight to about 30 parts by weight based on 100 parts by weight of the composition.

For example, the polymerizable component may be included in a weight ratio of about 5 parts by weight to about 25 parts by weight, about 8 parts by weight to about 20 parts by weight, about 10 parts by weight to about 20 parts by weight, or about 10 parts by weight to about 15 parts by weight based on 100 parts by weight of the composition.

According to an embodiment, the first component may include at least two different diamine compounds.

According to an embodiment, the diamine compounds may include 4,4′-diaminodiphenyl ether, p-phenylenediamine, 2,2′-bis(trifluoromethyl)benzidine, 3,3′-sulfonyl dianiline, 4,4′-diaminodiphenyl sulfone, bis[4-(4-aminophenoxy)phenyl]sulfone, 3,4′-oxydianiline, and 4,4′-(1,3-phenylenedioxy)dianiline, or any combination thereof.

According to an embodiment, the tetracarboxylic dianhydride may include biphenyl-tetracarboxylic dianhydride, benzophenone tetracarboxylic dianhydride, meso-butane-tetracarboxylic dianhydride, 2,2-bis(3,4-anhydrodicarboxyphenyl) hexafluoropropane dianhydride, 3,3′,4,4′-biphenyltetracarboxylic dianhydride, 3,3′,4,4′-diphenylsulfone tetracarboxylic dianhydride, 3,3′,4,4′-benzophenone tetracarboxylic dianhydride, or any combination thereof.

According to an embodiment, a viscosity of the composition may be about 1,000 cP to about 20,000 cP.

In the case where the viscosity is less than 1,000 cP, a relatively large amount of low-molecular-weight molecules and high flowability during coating may result in the formation of a thin polyimide film. In the case where the viscosity exceeds 20,000 cP, a large amount of polymers and low flowability may result in the formation of a considerably thick film. Therefore, it may be difficult to obtain an appropriate thickness of the polyimide film.

The viscosity of the composition may be measured by a Brookfield viscometer (Model No.: DV7TRVCP) at 25 °C.

### [Method of Preparing Polyimide Film]

According to an embodiment, a method of preparing a polyimide film includes:
applying a composition to a carrier substrate; and
forming a polyimide film via imidization by heating the composition,
wherein the composition includes
a polymerizable component including a diamine compound-containing first component and a tetracarboxylic dianhydride-containing second component, and
a solvent,
wherein the solvent includes a mixed solvent including two or more solvents, and
the mixed solvent includes an amide-based solvent and a sulfone-based solvent.

The composition is the same as that described above in the [Composition] section, and may be applied to the [Method of Preparing Polyimide Film] in the same manner.

According to an embodiment, the applying of the composition to a carrier substrate may include spin-coating or slit-coating the composition onto the carrier substrate.

According to an embodiment, the heating of the composition may be heating the composition at a temperature of about 50 °C to about 500 °C.

The polymerizable component contained in the composition is imidized by the heating, thereby forming a polyimide film.

According to an embodiment, the heating of the composition may include raising the temperature from a range of about 50 °C to about 150 °C to a range of about 400 °C to about 500 °C.

According to an embodiment, the method may further include drying the composition after heating the composition.

According to an embodiment, the drying of the composition may be performed for about 1 minute to about 30 minutes.

### [Polyimide Film]

According to an embodiment, a polyimide film may be prepared using the composition by the method of preparing a polyimide film. Further, according to an embodiment, the polyimide film can have a transmittance of 50% or more at a wavelength of 450 nm.

The composition and the polyimide film according to the disclosure may be prepared by using the mixed solvent of the amide-based solvent and the sulfone-based solvent instead of environmentally regulated solvents.

In addition, the composition and the polyimide film manufactured from the composition according to the disclosure may have enhanced surface characteristics and excellent thickness reliability.

In addition, the composition and the polyimide film manufactured from the composition according to the disclosure may have low variations in stress and strain, thereby having excellent reliability.

Therefore, by using the composition and the polyimide film manufactured from the composition according to the disclosure, high-quality electronic apparatuses and electronic devices may be provided.

### [Electronic Apparatus and Electronic Device]

According to another embodiment, an electronic apparatus including the above-described polyimide film is provided. The electronic apparatus may further include a transistor. For example, the electronic apparatus may further include a thin film transistor including a source electrode and a drain electrode, wherein a first electrode of the light-emitting element may be electrically connected to the source electrode or the drain electrode. Meanwhile, the electronic apparatus may further include a color filter, a color conversion layer, a touchscreen layer, a polarizing layer, or any combination thereof. Detailed descriptions of the electronic apparatus are as set forth herein.

According to another embodiment, an electronic device including the polyimide film and/or the electronic apparatus may be one selected from a flat panel display, a curved display, a computer monitor, a medical monitor, a television, an advertising board, indoor and/or outdoor lighting and/or signaling light, a head-up display, a fully or partially transparent display, a flexible display, a rollable display, a foldable display, a stretchable display, a laser printer, a telephone, a mobile phone, a tablet, a phablet, a personal digital assistant (PDA), a wearable device, a laptop computer, a digital camera, a camcorder, a viewfinder, a microdisplay, a 3D display, a virtual reality or augmented reality display, a vehicle, a video wall including tiled multiple displays, a theater or stadium screen, a phototherapy device, and a signboard.

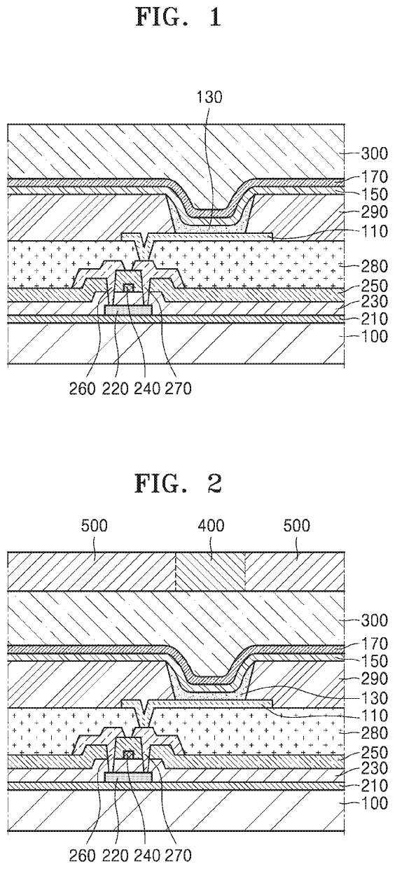

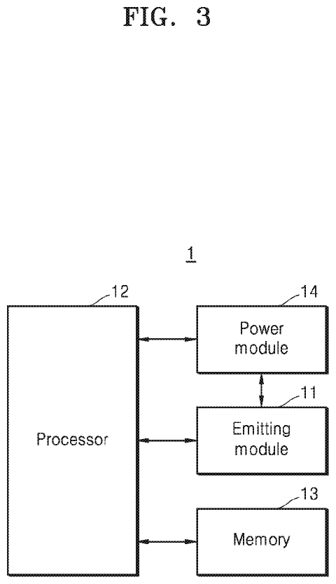

### DESCRIPTION OF FIGS. 1 AND 2

FIG. 1 is a cross-sectional view of a light-emitting device (electronic apparatus) according to an embodiment.

A light-emitting device of FIG. 1 includes a substrate 100, a thin film transistor (TFT), a light-emitting element, and an encapsulation region 300 configured to seal the light-emitting element.

The substrate 100 may be the polyimide film according to the disclosure.

A buffer layer 210 may be disposed on the substrate 100. The buffer layer 210 may serve to prevent penetration of impurities through the substrate 100 and provide a planar surface on the upper side of the substrate 100.

A thin film transistor TFT may be disposed on a buffer layer 210. The thin film transistor TFT may include an active layer 220, a gate electrode 240, a source electrode 260, and a drain electrode 270.

The active layer 220 may include an inorganic semiconductor such as silicon or polysilicon, an organic semiconductor, or an oxide semiconductor, and may include a source region, a drain region, and a channel region.

A gate insulating layer 230 may be disposed on the active layer 220 to insulate the active layer 220 from the gate electrode 240, and the gate electrode 240 may be disposed on the gate insulating layer 230.

An interlayer insulating layer 250 may be disposed on the gate electrode 240. The interlayer insulating layer 250 may be located between the gate electrode 240 and the source electrode 260, and between the gate electrode 240 and the drain electrode 270, serving to insulate them from each other.

The source electrode 260 and the drain electrode 270 may be disposed on the interlayer insulating layer 250. The interlayer insulating layer 250 and the gate insulating layer 230 may be formed to expose the source region and the drain region of the active layer 220, and the source electrode 260 and the drain electrode 270 may be disposed to contact the exposed source region and drain region of the active layer 220.

The thin film transistor TFT may be electrically connected to the light-emitting element to drive the light-emitting element and protected by a passivation layer 280 covering the same. The passivation layer 280 may include an inorganic insulating film, an organic insulating film, or any combination thereof. A light-emitting element is provided on the passivation layer 280. The light-emitting element includes a first electrode 110, an intermediate layer 130, and a second electrode 150.

The first electrode 110 may be disposed on the passivation layer 280. The passivation layer 280 may be arranged not to cover the entire area of the drain electrode 270 but to expose a certain area, and the first electrode 110 may be arranged to be connected to the exposed drain electrode 270.

A pixel-defining film 290 including an insulating material may be disposed on the first electrode 110. The pixel-defining film 290 may expose a certain area of the first electrode 110, and an intermediate layer 130 may be formed in the exposed area. The pixel-defining film 290 may be an organic film formed of polyimide or polyacrylate. Although not shown in FIG. 1, at least a portion of the intermediate layer 130 may extend over the pixel-defining film 290 to be arranged in the form of a common layer.

A second electrode 150 may be disposed on the intermediate layer 130, and a capping layer 170 may be additionally formed on the second electrode 150. The capping layer 170 may be formed to cover the second electrode 150.

The encapsulation region 300 may be disposed on the capping layer 170. The encapsulation region 300 may be disposed on the light-emitting element, serving to protect the light-emitting element from moisture or oxygen. The encapsulation region 300 may include an inorganic layer including silicon nitride (SiNₓ), silicon oxide (SiOₓ), indium tin oxide, indium zinc oxide, or any combination thereof, an organic layer including polyethylene terephthalate, polyethylene naphthalate, polycarbonate, polyimide, polyethylene sulfonate, polyoxymethylene, polyarylate, hexamethyldisiloxane, and acrylic resin (e.g., polymethyl methacrylate and polyacrylic acid), epoxy resin (e.g., aliphatic glycidyl ether (AGE)), or any combination thereof, or a combination of the inorganic layer and the organic layer.

FIG. 2 is a cross-sectional view of a light-emitting device according to another embodiment.

The light-emitting device of FIG. 2 is the same as the light-emitting device of FIG. 1, except that a light-shielding pattern 500 and a functional region 400 are additionally disposed on the encapsulation region 300. The functional region 400 may be i) a color filter region, ii) a color conversion region, or iii) a combination of the color filter region and the color conversion region. According to an embodiment, the light-emitting element included in the light-emitting device of FIG. 2 may be a tandem light-emitting element.

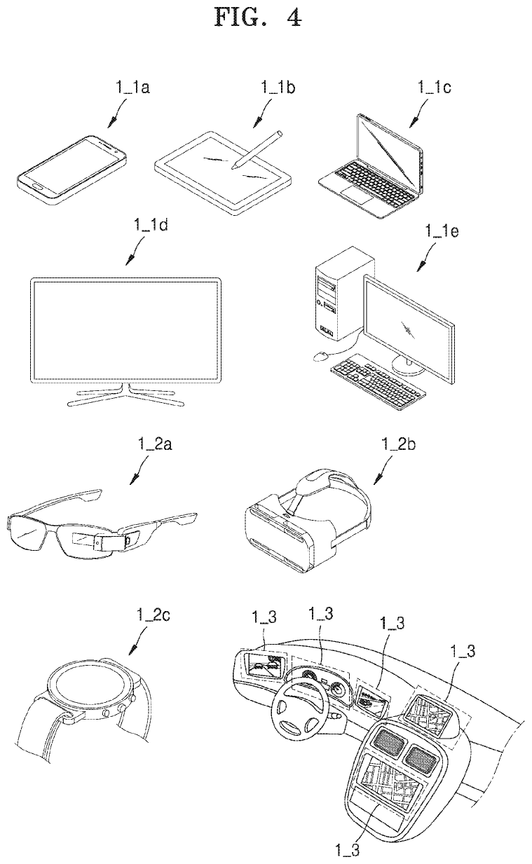

### DESCRIPTION OF FIG. 3

FIG. 3 is a block diagram of an electronic device 1 according to an embodiment. Referring to FIG. 3, the electronic device 1 according to an embodiment may include an emitting module 11, a processor 12, a memory 13, and a power module 14.

The processor 12 may include at least one of a central processing unit (CPU), an application processor (AP), a graphic processing unit (GPU), a communication processor (CP), an image signal processor (ISP), and a controller.

The memory 13 may store data information required for operation of the processor 12 or the emitting module 11. Upon execution of an application stored in the memory 13 by the processor 12, image data signals and/or input control signals are transmitted to the emitting module 11, and the emitting module 11 may be configured to process the received signals and output image information via a display screen.

The power module 14 may include a power supply module such as a power adapter or a battery device, and a power conversion module configured to convert the power supplied by the power supply module to generate power required for the operation of the electronic device 10.

At least one of the components of the above-described electronic device 1 may be included in the light-emitting device according to the embodiments described above. Alternatively, some of the individual modules functionally included in a single module may be included in the light-emitting device, and others may be provided separately from the light-emitting device. For example, the light-emitting device may include the emitting module 11, and the processor 12, the memory 13, and the power module 14 may be provided in the form of other devices in the electronic device 1 other than the light-emitting device.

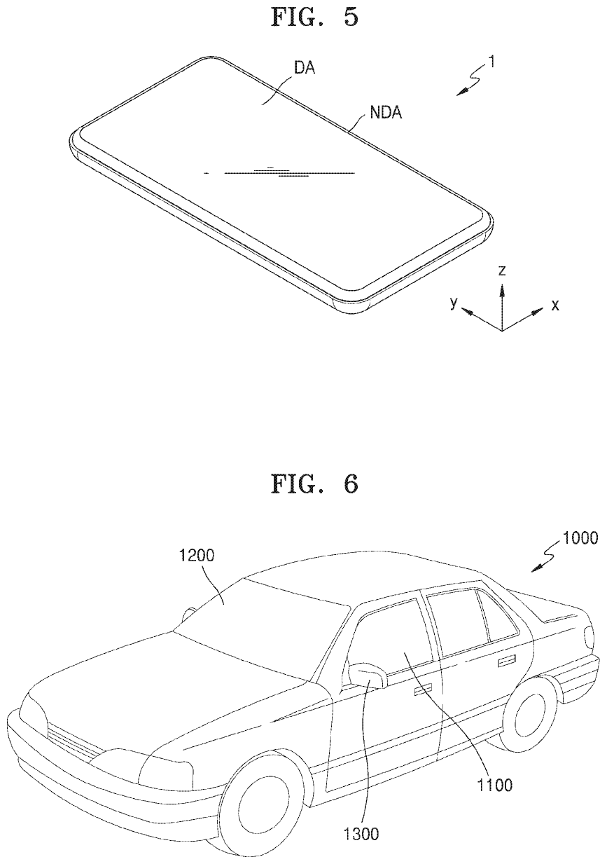

### DESCRIPTION OF FIG. 4

FIG. 4 shows schematic diagrams of electronic devices according to various embodiments.

Referring to FIG. 4, various electronic devices to which the electronic apparatus (e.g., light-emitting device) is applied may include not only electronic devices configured to display images such as a smart phone 1_1a, a tablet PC 1_1b, a laptop 1_1c, a TV 1_1d, and a desktop monitor 1_1e, but also wearable electronic devices including an emitting module such as smart glasses 1_2a, a head-mounted display 1_2b, and a smart watch 1_2c, and electronic devices for vehicles 1_3 including an emitting module such as an instrument cluster, a center fascia, a center information display (CID) arranged on dashboard, and a room mirror display.

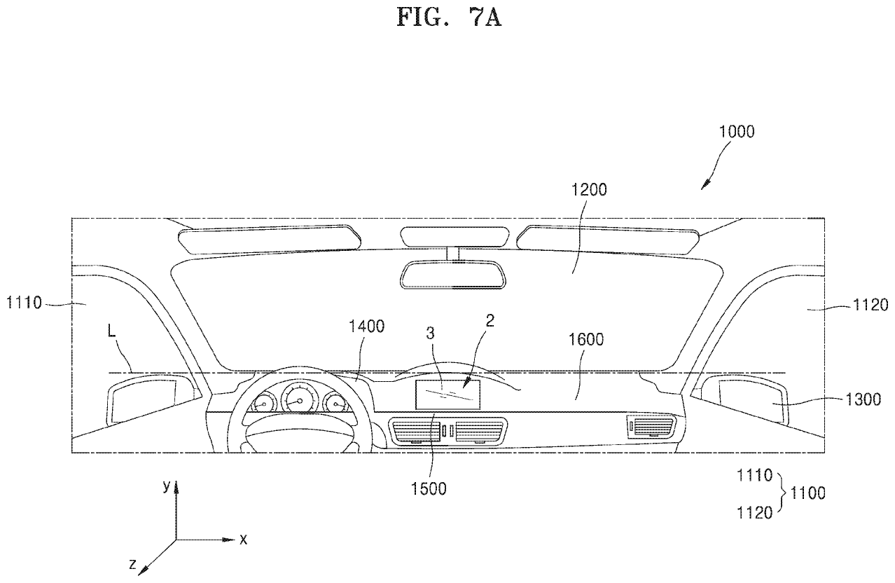

### DESCRIPTION OF FIG. 5

FIG. 5 is a perspective view schematically illustrating an electronic device 1 including a polyimide film according to an embodiment. The electronic device 1, as an apparatus used to display moving images or a still image, may be used not only as portable electronic devices such as mobile phones, smart phones, tablet personal computers (PCs), mobile communication terminals, electronic notebooks, electronic books, portable multimedia players (PMPs), navigation devices, and ultra mobile PCs (UMPCs), but also as various products such as televisions, laptops, monitors, billboards, and internet of things (IOT), or a part thereof. In addition, the electronic device 1 may be a wearable device such as a smart watch, a watch phone, a glasses type display, and a head mounted display (HMD), or a part thereof. However, the disclosure is not limited thereto. For example, the electronic device 1 may be instrument panels, a center information display disposed on center fascia or dashboards of vehicles, a room mirror display replacing side mirrors, a device for entertainment of backseats of vehicles, a display disposed on the rear surface of front seats, a head-up display (HUD) installed at the front of a vehicle or projected onto the front windshield glass, or a computer-generated hologram augmented reality head-up display (CGH AR HUD). FIG. 5 illustrates a case where the electronic device 1 is a smartphone for the convenience of description.

The electronic device 1 may have a display area DA and a non-display area NDA arranged outside the display area DA. The display device may realize an image by an array of a plurality of pixels two-dimensionally arranged in the display area DA.

The non-display area NDA is an area that does not display an image and may surround the entire display area DA. A driver and other components configured to provide electrical signals or power to the display elements arranged in the display area DA may be arranged in the non-display area NDA. Pads, which are areas electrically connected to electronic elements or printed circuit boards, may be arranged in the non-display area NDA.

The electronic device 1 may have different lengths in the x-axis direction and the y-axis direction. For example, as shown in FIG. 5, the length in the x-axis direction may be shorter than that in the y-axis direction. As another example, the length in the x-axis direction may be the same as that in the y-axis direction. As another example, the length in the x-axis direction may be longer than that in the y-axis direction.

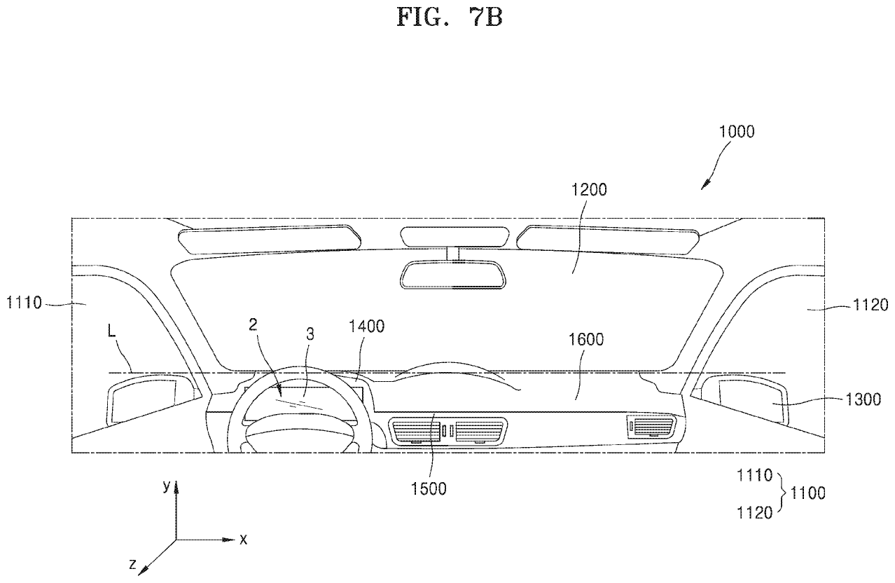

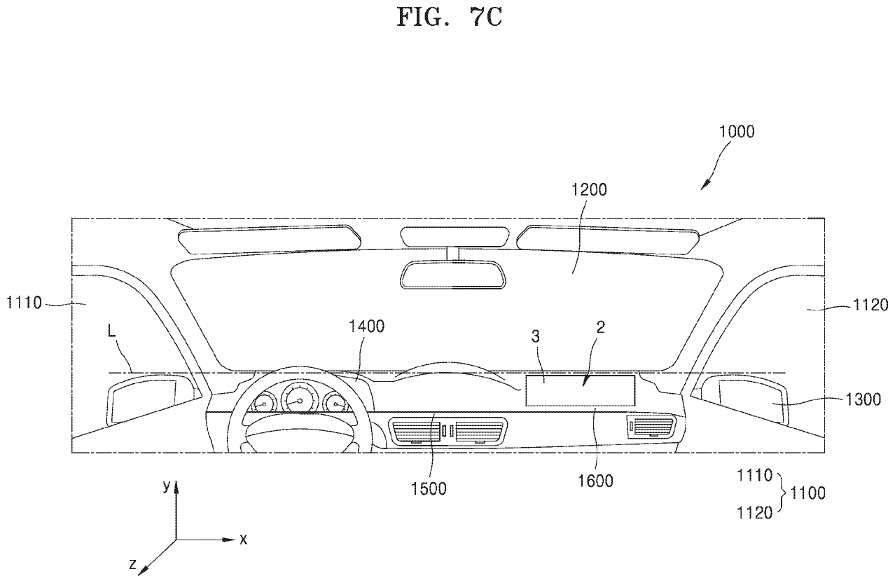

### DESCRIPTION OF FIGS. 6 AND 7A TO 7C

FIG. 6 is a diagram schematically illustrating aspects of the exterior of a vehicle 1000 as electronic devices including a polyimide film according to an embodiment. FIGS. 7A to 7C are diagrams schematically illustrating the interior of vehicles 1000 according to various embodiments.

Referring to FIGS. 6, 7A, 7B, and 7C, the vehicle 1000 may refer to various apparatuses that transport passengers, goods, or animals from a starting point to a destination. The vehicle 1000 may include cars that travel on roads or tracks, ships that travel on seas or rivers, and airplanes that fly through the air.

The vehicle 1000 may travel on roads or tracks. The vehicle 1000 may move in a certain direction depending on the rotation of at least one wheel. For example, the vehicle 1000 may include three-wheeled or four-wheeled cars, construction machinery, motorcycles, moto devices, bicycles, and trains traveling on tracks.

The vehicle 1000 may include a body having an interior and an exterior, and a chassis including mechanical devices required for driving, excluding the body. The exterior of the body may include a front panel, a bonnet, a roof panel, a rear panel, a trunk, and a pillar provided at the boundaries between the doors. The chassis of the vehicle 1000 may include a power generation device, a power transmission device, a driving device, a steering device, a braking device, a suspension device, a transmission device, a fuel device, and wheels on all sides.

The vehicle 1000 may include a side window glass 1100, a front window glass 1200, side mirrors 1300, a cluster 1400, a center fascia 1500, a passenger side dashboard 1600, and a display device 2.

The side window glass 1100 and the front window glass 1200 may be separated by a pillar arranged between the side window glass 1100 and the front window glass 1200.

The side window glass 1100 may be installed on sides of the vehicle 1000. In an embodiment, the side window glass 1100 may be installed on the doors of the vehicle 1000. The side window glass 1100 may be provided in multiple pieces facing each other. In an embodiment, the side window glass 1100 may include a first side window glass 1110 and a second side window glass 1120. In an embodiment, the first side window glass 1110 may be arranged adjacent to the cluster 1400. The second side window glass 1120 may be arranged adjacent to the passenger side dashboard 1600.

In an embodiment, the side window glasses 1100 may be spaced apart from each other in the x direction or −x direction. For example, the first side window glass 1110 and the second side window glass 1120 may be spaced apart from each other in the x direction or −x direction. In other words, a virtual straight line L connecting the side window glasses 1100 may extend in the x direction or −x direction. For example, the virtual straight line L connecting the first side window glass 1110 and the second side window glass 1120 may extend in the x direction or −x direction.

The front window glass 1200 may be installed at the front of the vehicle 1000. The front window glass 1200 may be located between the side window glasses 1100 facing each other.

The side mirrors 1300 may provide a view of the rear of the vehicle 1000. The side mirrors 1300 may be installed on the exterior of the body. In an embodiment, the side mirrors 1300 may be provided in plural. One of the plurality of side mirrors 1300 may be located on the outside of the first side window glass 1110. Another of the plurality of side mirrors 1300 be located on the outside of the second side window glass 1120.

The cluster 1400 may be located in front of a steering wheel. The cluster 1400 may include a tachometer, a speedometer, a coolant temperature gauge, a fuel gauge, a direction indicator, a high beam indicator, a warning light, a seatbelt warning light, an odometer, a trip meter, an automatic transmission shift lever indicator, a door open warning light, an engine oil warning light, and/or a low fuel warning light.

The center fascia 1500 may include a control panel with a plurality of buttons arranged to adjust an audio device, an air conditioning system, and a seat heater. The center fascia 1500 may be located on one side of the cluster 1400.

The passenger side dashboard 1600 may be spaced apart from the cluster 1400, with the center fascia 1500 therebetween. In an embodiment, the cluster 1400 may be positioned to correspond to the driver's side (not shown), and the passenger side dashboard 1600 may be positioned to correspond to the passenger's side (not shown). In an embodiment, the cluster 1400 may be adjacent to the first side window glass 1110, and the passenger side dashboard 1600 may be adjacent to the second side window glass 1120.

In an embodiment, the display device 2 may include a display panel 3, and the display panel 3 may display an image. The display device 2 may be located inside the vehicle 1000. In an embodiment, the display device 2 may be located between the side window glasses 1100 facing each other. The display device 2 may be positioned on at least one of the cluster 1400, the center fascia 1500, or the passenger side dashboard 1600.

The display device 2 may include an organic light emitting display, an inorganic light emitting display, and a quantum dot display. Hereinafter, an organic light emitting display device including the polyimide film according to the disclosure will be described as an example of the display device 2 according to an embodiment, but various types of other display devices as described above may also be used.

Referring to FIG. 7A, the display device 2 may be located on the center fascia 1500. In an embodiment, the display device 2 may display navigation information. In an embodiment, the display device 2 may display information on audios, videos, or vehicle settings.

Referring to FIG. 7B, the display device 2 may be located on the cluster 1400. In this case, the cluster 1400 may represent driving information, and the like, via the display device 2. That is, the cluster 1400 may be implemented in a digital format. The cluster 1400 operated in a digital manner may display vehicle information and driving information as images. For example, the needle of the tachometer, the gauges, and various warning light icons may be displayed using digital signals.

Referring to FIG. 7C, the display device 2 may be located on the passenger side dashboard 1600. The display device 2 may be embedded in or located on the passenger side dashboard 1600. In an embodiment, the display device 2 located on the passenger side dashboard 1600 may display images related to the information shown on the cluster 1400 and/or the center fascia 1500. In another embodiment, the display device 2 located on the passenger side dashboard 1600 may display information different from that shown on the cluster 1400 and/or the center fascia 1500.

### DEFINITION OF TERMS

As used herein, the C₃-C₆₀ carbocyclic group refers to a cyclic group formed of only carbon atoms as ring-forming atoms and including 3 to 60 carbon atoms, and the C₁-C₆₀ heterocyclic group refers to a cyclic group further including hetero atoms as ring-forming atoms in addition to carbon atoms and including 1 to 60 carbon atoms. Each of the C₃-C₆₀ carbocyclic group and the C₁-C₆₀ heterocyclic group may be a monocyclic group formed of one ring or a polycyclic group formed of two or more rings fused together. For example, the number of the ring-forming atoms of the C₁-C₆₀ heterocyclic group may be 3 to 61.

As used herein, the cyclic group includes both the C₃-C₆₀ carbocyclic group and the C₁-C₆₀ heterocyclic group.

As used herein, the π electron-rich C₃-C₆₀ cyclic group is a ring-forming moiety and refers to a cyclic group having 3 to 60 carbon atoms and not including *—N═*′, and the π electron-deficient nitrogen-containing C₁-C₆₀ cyclic group is a ring-forming moiety and refers to a heterocyclic group having 1 to 60 carbon atoms and including *—N═*′.

For example,
the C₃-C₆₀ carbocyclic group may be i) group T1 (defined subsequently) or ii) a condensed ring group in which 2 or more group T1s are condensed (e.g., a cyclopentadiene group, an adamantane group, a norbornane group, a benzene group, a pentalene group, a naphthalene group, an azulene group, an indacene group, an acenaphthylene group, a phenalene group, a phenanthrene group, an anthracene group, a fluoranthene group, a triphenylene group, a pyrene group, a chrysene group, a perylene group, a pentaphene group, a heptalene group, a naphthacene group, a picene group, a hexacene group, a pentacene group, a rubicene group, a coronene group, an ovalene group, an indene group, a fluorene group, a spiro-bifluorene group, a benzofluorene group, an indenophenanthrene group, or an indenoanthracene group),
the C₁-C₆₀ heterocyclic group may be i) group T2 (defined subsequently), ii) a condensed ring group in which 2 or more group T2s are condensed, or iii) a condensed ring group in which 1 or more group T2s and 1 or more group T1s are condensed (e.g., a pyrrole group, a thiophene group, a furan group, an indole group, a benzoindole group, a naphthoindole group, an isoindole group, a benzoisoindole group, a naphthoisoindole group, a benzosilole group, a benzothiophene group, a benzofuran group, a carbazole group, a dibenzosilole group, a dibenzothiophene group, a dibenzofuran group, an indenocarbazole group, an indolocarbazole group, a benzofurocarbazole group, a benzothienocarbazole group, a benzosilolocarbazole group, a benzoindolocarbazole group, a benzocarbazole group, a benzonaphthofuran group, a benzonapthothiophene group, a benzonaphthosilole group, a benzofurodibenzofuran group, a benzofurodibenzothiophene group, a benzothienodibenzothiophene group, a pyrazole group, an imidazole group, a triazole group, an oxazole group, an isoxazole group, an oxadiazole group, a thiazole group, an isothiazole group, a thiadiazole group, a benzopyrazole group, a benzimidazole group, a benzoxazole group, a benzoisoxazole group, a benzothiazole group, a benzoisothiazole group, a pyridine group, a pyrimidine group, a pyrazine group, a pyridazine group, a triazine group, a quinoline group, an isoquinoline group, a benzoquinoline group, a benzoisoquinoline group, a quinoxaline group, a benzoquinoxaline group, a quinazoline group, a benzoquinazoline group, a phenanthroline group, a cinnoline group, a phthalazine group, a naphthyridine group, an imidazopyridine group, an imidazopyrimidine group, an imidazotriazine group, an imidazopyrazine group, an imidazopyridazine group, an azacarbazole group, an azafluorene group, an azadibenzosilole group, an azadibenzothiophene group, or an azadibenzofuran group),
the π electron-rich C₃-C₆₀ cyclic group may be i) group T1, ii) a condensed ring in which 2 or more group T1s are condensed, iii) group T3 (defined subsequently), iv) a condensed ring in which 2 or more group T3s are condensed, or v) a condensed ring in which 1 or more group T3s and 1 or more group T1s are condensed (e.g., the C₃-C₆₀ carbocyclic group, a 1H-pyrrole group, a silole group, a borole group, a 2H-pyrrole group, a 3H-pyrrole group, a thiophene group, a furan group, an indole group, a benzoindole group, a naphthoindole group, an isoindole group, a benzoisoindole group, a naphthoisoindole group, a benzosilole group, a benzothiophene group, a benzofuran group, a carbazole group, a dibenzosilole group, a dibenzothiophene group, a dibenzofuran group, an indenocarbazole group, an indolocarbazole group, a benzofurocarbazole group, a benzothienocarbazole group, a benzosilolocarbazole group, a benzoindolocarbazole group, a benzocarbazole group, a benzonaphthofuran group, a benzonapthothiophene group, a benzonaphthosilole group, a benzofurodibenzofuran group, a benzofurodibenzothiophene group, or a benzothienodibenzothiophene group),
the π electron-deficient nitrogen-containing C₁-C₆₀ cyclic group may be i) group T4 (defined subsequently), ii) a condensed ring in which 2 or more group T4s are condensed, iii) a condensed ring in which 1 or more group T4s and 1 or more group T1s are condensed, iv) a condensed ring in which 1 or more group T4s and 1 or more group T3s are condensed, or v) a condensed ring in which 1 or more group T4s, 1 or more group T1s, and 1 or more group T3s are condensed (e.g., a pyrazole group, an imidazole group, a triazole group, an oxazole group, an isoxazole group, an oxadiazole group, a thiazole group, an isothiazole group, a thiadiazole group, a benzopyrazole group, a benzimidazole group, a benzoxazole group, a benzoisoxazole group, a benzothiazole group, a benzoisothiazole group, a pyridine group, a pyrimidine group, a pyrazine group, a pyridazine group, a triazine group, a quinoline group, an isoquinoline group, a benzoquinoline group, a benzoisoquinoline group, a quinoxaline group, a benzoquinoxaline group, a quinazoline group, a benzoquinazoline group, a phenanthroline group, a cinnoline group, a phthalazine group, a naphthyridine group, an imidazopyridine group, an imidazopyrimidine group, an imidazotriazine group, an imidazopyrazine group, an imidazopyridazine group, an azacarbazole group, an azafluorene group, an azadibenzosilole group, an azadibenzothiophene group, or an azadibenzofuran group),
the group T1 may be a cyclopropane group, a cyclobutane group, a cyclopentane group, a cyclohexane group, a cycloheptane group, a cyclooctane group, a cyclobutene group, a cyclopentene group, a cyclopentadiene group, a cyclohexene group, a cyclohexadiene group, a cycloheptene group, an adamantane group, a norbornane (or bicyclo[2.2.1]heptane group), a norbornene group, a bicyclo[1.1.1]pentane group, a bicyclo[2.1.1]hexane group, a bicyclo[2.2.2]octane group, or a benzene group,
the group T2 may be a furan group, a thiophene group, a 1H-pyrrole group, a silole group, a borole group, a 2H-pyrrole group, a 3H-pyrrole group, an imidazole group, a pyrazole group, a triazole group, a tetrazole group, an oxazole group, an isoxazole group, an oxadiazole group, a thiazole group, an isothiazole group, a thiadiazole group, an azasilole group, an azaborole group, a pyridine group, a pyrimidine group, a pyrazine group, a pyridazine group, a triazine group, a tetrazine group, a pyrrolidine group, an imidazolidine group, a dihydropyrrole group, a piperidine group, a tetrahydropyridine group, a dihydropyridine group, a hexahydropyrimidine group, a tetrahydropyrimidine group, a dihydropyrimidine group, a piperazine group, a tetrahydropyrazine group, a dihydropyrazine group, a tetrahydropyridazine group, or a dihydropyridazine group,
the group T3 may be a furan group, a thiophene group, a 1H-pyrrole group, a silole group, or a borole group, and
the group T4 may be a 2H-pyrrole group, a 3H-pyrrole group, an imidazole group, a pyrazole group, a triazole group, a tetrazole group, an oxazole group, an isoxazole group, an oxadiazole group, a thiazole group, an isothiazole group, a thiadiazole group, an azasilole group, an azaborole group, a pyridine group, a pyrimidine group, a pyrazine group, a pyridazine group, a triazine group, or a tetrazine group.

As used herein, the term cyclic group, C₃-C₆₀ carbocyclic group, C₁-C₆₀ heterocyclic group, π electron-rich C₃-C₆₀ cyclic group, or π electron-deficient nitrogen-containing C₁-C₆₀ cyclic group may be a group condensed to any cyclic group, a monovalent group, or a polyvalent group (e.g., divalent group, trivalent group, and tetravalent group) according to the structure of a chemical formula in which the term is used. For example, the “benzene group” may be a benzo group, a phenyl group, a phenylene group, and the like, which may be easily understood by those skilled in the art depending on the structure of a chemical formula including the “benzene group.”

For example, examples of the monovalent C₃-C₆₀ carbocyclic group and the monovalent C₁-C₆₀ heterocyclic group may include a C₃-C₁₀ cycloalkyl group, a C₁-C₁₀ heterocycloalkyl group, a C₃-C₁₀ cycloalkenyl group, a C₁-C₁₀ heterocycloalkenyl group, a C₆-C₆₀ aryl group, a C₁-C₆₀ heteroaryl group, a monovalent non-aromatic condensed polycyclic group, and a monovalent non-aromatic condensed heteropolycyclic group, and examples of the divalent C₃-C₆₀ carbocyclic group and the divalent C₁-C₆₀ heterocyclic group may include a C₃-C₁₀ cycloalkylene group, a C₁-C₁₀ heterocycloalkylene group, a C₃-C₁₀ cycloalkenylene group, a C₁-C₁₀ heterocycloalkenylene group, a C₆-C₆₀ arylene group, a C₁-C₆₀ heteroarylene group, a divalent non-aromatic condensed polycyclic group, and a divalent non-aromatic condensed heteropolycyclic group.

As used herein, the C₁-C₆₀ alkyl group refers to a linear or branched monovalent aliphatic hydrocarbon group including 1 to 60 carbon atoms, and examples thereof include a methyl group, an ethyl group, an n-propyl group, an isopropyl group, an n-butyl group, a sec-butyl group, an isobutyl group, a tert-butyl group, an n-pentyl group, a tert-pentyl group, a neopentyl group, an isopentyl group, a sec-pentyl group, a 3-pentyl group, a sec-isopentyl group, an n-hexyl group, an isohexyl group, a sec-hexyl group, a tert-hexyl group, an n-heptyl group, an isoheptyl group, a sec-heptyl group, a tert-heptyl group, an n-octyl group, an isooctyl group, a sec-octyl group, a tert-octyl group, an n-nonyl group, an isononyl group, a sec-nonyl group, a tert-nonyl group, an n-decyl group, an isodecyl group, a sec-decyl group, and a tert-decyl group. As used herein, the C₁-C₆₀ alkylene group refers to a divalent group having the same structure as that of the C₁-C₆₀ alkyl group except for the number of attachment points for bonding to other atoms or groups.

As used herein, the C₂-C₆₀ alkenyl group refers to a monovalent hydrocarbon group including at least one carbon-carbon double bond in the middle or at a terminal of the C₂-C₆₀ alkyl group, and examples thereof include an ethenyl group, a propenyl group, and a butenyl group. As used herein, the C₂-C₆₀ alkenylene group refers to a divalent group having the same structure as that of the C₂-C₆₀ alkenyl group except for the number of attachment points for bonding to other atoms or groups.

As used herein, the C₂-C₆₀ alkynyl group refers to a monovalent hydrocarbon group including at least one carbon-carbon triple bond in the middle or at a terminal of the C₂-C₆₀ alkyl group, and examples thereof include an ethynyl group and a propynyl group. As used herein, the C₂-C₆₀ alkynylene group refers to a divalent group having the same structure as that of the C₂-C₆₀ alkynyl group except for the number of attachment points for bonding to other atoms or groups.

As used herein, the C₁-C₆₀ alkoxy group refers to a monovalent group having a chemical formula of —OA₁₀₁ (where A₁₀₁ is a C₁-C₆₀ alkyl group), and examples thereof include a methoxy group, an ethoxy group, and an isopropyloxy group.

As used herein, the C₃-C₁₀ cycloalkyl group refers to a monovalent saturated hydrocarbon cyclic group containing 3 to 10 carbon atoms, and examples thereof include a cyclopropyl group, a cyclobutyl group, a cyclopentyl group, a cyclohexyl group, a cycloheptyl group, a cyclooctyl group, an adamantanyl group, a norbornanyl group (or, bicyclo[2.2.1]heptyl), bicyclo[1.1.1]pentyl, bicyclo[2.1.1]hexyl, and bicyclo[2.2.2]octyl group. As used herein, the C₃-C₁₀ cycloalkylene group refers to a divalent group having the same structure as that of the C₃-C₁₀ cycloalkyl group except for the number of attachment points for bonding to other atoms or groups.

As used herein, the C₁-C₁₀ heterocycloalkyl group refers to a monovalent cyclic group containing 1 to 10 carbon atoms and further including at least one hetero atom as a ring-forming atom, and examples thereof include a 1,2,3,4-oxatriazolidinyl group, a tetrahydrofuranyl group, and a tetrahydrothiophenyl group. As used herein, the C₁-C₁₀ heterocycloalkylene group refers to a divalent group having the same structure as that of the C₁-C₁₀ heterocycloalkyl group except for the number of attachment points for bonding to other atoms or groups.

As used herein, the C₃-C₁₀ cycloalkenyl group refers to a monovalent cyclic group containing 3 to 10 carbon atoms and including at least one carbon-carbon double bond within the ring without aromaticity, and examples thereof include a cyclopentenyl group, a cyclohexenyl group, and a cycloheptenyl group. As used herein, the C₃-C₁₀ cycloalkenylene group refers to a divalent group having the same structure as that of the C₃-C₁₀ cycloalkenyl group except for the number of attachment points for bonding to other atoms or groups.

As used herein, the C₁-C₁₀ heterocycloalkenyl group refers to a monovalent cyclic group containing 1 to 10 carbon atoms and further including at least one hetero atom as a ring-forming atom in addition to carbon atoms with at least one double bond within the ring. Examples of the C₁-C₁₀ heterocycloalkenyl group include 4,5-dihydro-1,2,3,4-oxatriazolyl group, a 2,3-dihydrofuranyl group, and a 2,3-dihydrothiophenyl group. As used herein, the C₁-C₁₀ heterocycloalkenylene group refers to a divalent group having the same structure as that of the C₁-C₁₀ heterocycloalkenyl group except for the number of attachment points for bonding to other atoms or groups.

As used herein, the C₆-C₆₀ aryl group refers to a monovalent group having a carbocyclic aromatic system containing 6 to 60 carbon atoms, and the C₆-C₆₀ arylene group refers to a divalent group having a carbocyclic aromatic system containing 6 to 60 carbon atoms. Examples of the C₆-C₆₀ aryl group include a phenyl group, a pentalenyl group, a naphthyl group, an azulenyl group, an indacenyl group, an acenaphthyl group, a phenalenyl group, a phenanthrenyl group, an anthracenyl group, a fluoranthenyl group, a triphenylenyl group, a pyrenyl group, a chrysenyl group, a perylenyl group, a pentaphenyl group, a heptalenyl group, a naphthacenyl group, a picenyl group, a hexacenyl group, a pentacenyl group, a rubicenyl group, a coronenyl group, and an ovalenyl group. In the case where the C₆-C₆₀ aryl group and the C₆-C₆₀ arylene group include two or more rings, the two or more rings may be condensed with each other.

As used herein, the C₁-C₆₀ heteroaryl group refers to a monovalent group having a heterocyclic aromatic system containing 1 to 60 carbon atoms and further including at least one hetero atom as a ring-forming atom in addition to carbon atoms, and the C₁-C₆₀ heteroarylene group refers to a divalent group having a heterocyclic aromatic system containing 1 to 60 carbon atoms and further including at least one hetero atom as a ring-forming atom in addition to carbon atoms. Examples of the C₁-C₆₀ heteroaryl group include a pyridinyl group, a pyrimidinyl group, a pyrazinyl group, a pyridazinyl group, a triazinyl group, a quinolinyl group, a benzoquinolinyl group, an isoquinolinyl group, a benzoisoquinolinyl group, a quinoxalinyl group, a benzoquinoxalinyl group, a quinazolinyl group, a benzoquinazolinyl group, a cinnolinyl group, a phenanthrolinyl group, a phthalazinyl group, and a naphthyridinyl group. In the case where the C₁-C₆₀ heteroaryl group and the C₁-C₆₀ heteroarylene group include two or more rings, the two or more rings may be condensed with each other.

As used herein, the monovalent non-aromatic condensed polycyclic group refers to a monovalent group containing only carbon atoms (e.g., 8 to 60 carbon atoms) as ring-forming atoms and having non-aromaticity in which two or more rings are condensed with each other. For purposes of this application, examples of the monovalent non-aromatic condensed polycyclic group include an indenyl group, a fluorenyl group, a spiro-bifluorenyl group, a benzofluorenyl group, an indenophenanthrenyl group, and an indenoanthracenyl group. As used herein, the divalent non-aromatic condensed polycyclic group refers to a divalent group having the same structure as that of the monovalent non-aromatic condensed polycyclic group except for the number of attachment points for bonding to other atoms or groups.

As used herein, the monovalent non-aromatic condensed heteropolycyclic group refers to a monovalent group (e.g., including 1 to 60 carbon atoms) having at least one hetero atom as a ring-forming atom in addition to carbon atoms with non-aromaticity in which two or more rings are condensed with each other. For purposes of this application, examples of the monovalent non-aromatic condensed heteropolycyclic group include a pyrrolyl group, a thiophenyl group, a furanyl group, an indolyl group, a benzoindolyl group, a naphthoindolyl group, an isoindolyl group, a benzoisoindolyl group, a naphthoisoindolyl group, a benzosilolyl group, a benzothiophenyl group, a benzofuranyl group, a carbazolyl group, a dibenzosilolyl group, a dibenzothiophenyl group, a dibenzofuranyl group, an azacarbazolyl group, an azafluorenyl group, an azadibenzosilolyl group, an azadibenzothiophenyl group, an azadibenzofuranyl group, a pyrazolyl group, an imidazolyl group, a triazolyl group, a tetrazolyl group, an oxazolyl group, an isoxazolyl group, a thiazolyl group, an isothiazolyl group, an oxadiazolyl group, a thiadiazolyl group, a benzopyrazolyl group, a benzoimidazolyl group, a benzoxazolyl group, a benzothiazolyl group, a benzoxadiazolyl group, a benzothiadiazolyl group, an imidazopyridinyl group, an imidazopyrimidinyl group, an imidazotriazinyl group, an imidazopyrazinyl group, an imidazopyridazinyl group, an indenocarbazolyl group, an indolocarbazolyl group, a benzofurocarbazolyl group, a benzothienocarbazolyl group, a benzosilolocarbazolyl group, a benzoindolocarbazolyl group, a benzocarbazolyl group, a benzonaphthofuranyl group, a benzonaphthothiophenyl group, a benzonaphthosilolyl group, a benzofurodibenzofuranyl group, a benzofurodibenzothiophenyl group, and a benzothienodibenzothiophenyl group. As used herein, the divalent non-aromatic condensed heteropolycyclic group refers to a divalent group having the same structure as that of the monovalent non-aromatic condensed heteropolycyclic group except for the number of attachment points for bonding to other atoms or groups.

As used herein, the C₆-C₆₀ aryloxy group is —OA₁₀₂ (wherein A₁₀₂ is a C₆-C₆₀ aryl group), and the C₆-C₆₀ arylthio group is —SA₁₀₃ (wherein A₁₀₃ is a C₆-C₆₀ aryl group).

As used herein, the C₇-C₆₀ arylalkyl group is -A₁₀₄A₁₀₅ (wherein A₁₀₄ is a C₁-C₅₄ alkylene group, and A₁₀₅ is a C₆-C₅₉ aryl group), and as used herein, the C₂-C₆₀ heteroarylalkyl group is -A₁₀₆A₁₀₇ (wherein A₁₀₆ is a C₁-C₅₉ alkylene group, and A₁₀₇ is a C₁-C₅₉ heteroaryl group).

As used herein, “R₁₀ₐ” may be
deuterium (-D), —F, —Cl, —Br, —I, a hydroxyl group, a cyano group, or a nitro group;
a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₃-C₆₀ carbocyclic group, a C₁-C₆₀ heterocyclic group, a C₆-C₆₀ aryloxy group, a C₆-C₆₀ arylthio group, a C₁-C₆₀ heteroaryloxy group, a C₁-C₆₀ heteroarylthio group, a C₇-C₆₀ arylalkyl group, a C₂-C₆₀ heteroarylalkyl group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or any combination thereof;
a C₃-C₆₀ carbocyclic group, a C₁-C₆₀ heterocyclic group, a C₆-C₆₀ aryloxy group, a C₆-C₆₀ arylthio group, a C₁-C₆₀ heteroaryloxy group, a C₁-C₆₀ heteroarylthio group, a C₇-C₆₀ arylalkyl group, or a C₂-C₆₀ heteroarylalkyl group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₃-C₆₀ carbocyclic group, a C₁-C₆₀ heterocyclic group, a C₆-C₆₀ aryloxy group, a C₆-C₆₀ arylthio group, a C₁-C₆₀ heteroaryloxy group, a C₁-C₆₀ heteroarylthio group, a C₇-C₆₀ arylalkyl group, a C₂-C₆₀ heteroarylalkyl group, —Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or
—Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂).

As used herein, Q₁ to Q₃, Q₁₁ to Q₁₃, Q₂₁ to Q₂₃, and Q₃₁ to Q₃₃ are each independently: hydrogen; deuterium; —F; —Cl; —Br; —I; a hydroxyl group; a cyano group; a nitro group; or a C₁-C₆₀ alkyl group, a C₂-C₆₀ alkenyl group, a C₂-C₆₀ alkynyl group, a C₁-C₆₀ alkoxy group, a C₁-C₆₀ alkylthio group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, or a C₂-C₆₀ heteroarylalkyl group, each unsubstituted or substituted with deuterium, —F, a cyano group, a C₁-C₆₀ alkyl group, a C₁-C₆₀ alkoxy group, a phenyl group, a biphenyl group, a pyridinyl group, a pyrimidinyl group, a pyridazinyl group, a pyrazinyl group, a triazinyl group, or any combination thereof.

As used herein, the hetero atom refers to an atom other than a carbon atom. Examples of the hetero atom include O, S, N, P, Si, B, Ge, and Se, and any combination thereof can be used in this disclosure.

As used herein, “Ph” refers to phenyl group, “Me” refers to methyl group, “Et” refers to ethyl group, “tert-Bu” or “But” refers to tert-butyl group, and “OMe” refers to methoxy group.

As used herein, the “biphenyl group” refers to “phenyl group substituted with a phenyl group.” The “biphenyl group” belongs to “substituted phenyl group” including a “C₆-C₆₀ aryl group” as a substituent.

As used herein, the “terphenyl group” refers to “phenyl group substituted with a biphenyl group.” The “terphenyl group” belongs to “substituted phenyl group” including a “C₆-C₆₀ aryl group substituted with a C₆-C₆₀ aryl group” as a substituent.

As used herein, * and *′ represent binding sites with neighboring atoms in the relevant formula or moiety, unless otherwise defined.

As used herein, the x-axis, the y-axis, and the z-axis are not limited to the three axes of an orthogonal coordinate system, but may be interpreted in a broader sense including the same. For example, the x-axis, the y-axis, and the z-axis may be orthogonal to each other, but may not be orthogonal to one another facing different directions.

### EXAMPLES

### Example 1: Preparation of Polyimide Film

Biphenyl-tetracarboxylic dianhydride, 4,4-diaminodiphenyl ether, and p-phenylenediamine were mixed at a molar ratio of 2:1:1 in a mixed solvent of dimethylpropionamide and sulfolane (tetramethylene sulfone), mixed in a weight ratio of 8:2, to prepare a polyamic acid composition with a solid content of 12%. The polyamic acid composition was applied to a glass substrate (carrier substrate) by a slot coater to prepare a polyamic acid film. The prepared film was heated from 100 °C to 450 °C at a rate of 8 °C/min, and then dried at 450 °C for 10 minutes and imidized to obtain a 10 μm-thick polyimide film.

### Example 2, Example 3, and Comparative Examples 1 to 3

Polyimide films were prepared in the same manner as in Example 1, except that solvents listed in Table 1 were used instead of the mixed solvent of dimethylpropionamide and sulfolane, mixed in a weight ratio of 8:2, in the preparation of the polyamic acid composition.

### Evaluation Example 1: Surface Characteristics

Surfaces of the polyimide films of Examples 1 to 3 and Comparative Examples 1 to 3 were evaluated, and the results are shown in Table 1 below.

The surfaces of the polyimide films were graded based on the number of bubbles formed on the surface, Grade A (≤1), Grade B (≤3), or Grade C (>3).

### Evaluation Example 2: Thickness Characteristics

Thicknesses of the polyimide films of Examples 1 to 3 and Comparative Examples 1 to 3 were evaluated, and the results are shown in Table 1 below.

The thicknesses of the polyimide films were measured by using a thickness measurement device (Spectroscopic Reflectometer) based on a reflected light measurement method, and thicknesses were measured at 9 different points across various areas of the substrate, and the standard deviation of thickness values at different positions of the film was calculated.

TABLE 1

| | | | Standard |
|---|---|---|---|
| | Solvent (weight | Surface | deviation of |
| | ratio) | characteristics | thickness |
| Example 1 | DMPA:sulfolane (8:2) | A | ≤0.2 μm |
| Example 2 | DMPA:sulfolane (5:5) | A | ≤0.2 μm |
| Example 3 | DMPA:sulfolane (99:1) | A | ≤0.2 μm |
| Comparative | DMPA | C | ≤0.5 μm |
| Example 1 | | | |
| Comparative | NEP | C | ≤0.6 μm |
| Example 2 | | | |
| Comparative | NMP | B | ≤0.3 μm |
| Example 3 | | | |

Referring to Table 1, it was confirmed that surface characteristics of the polyimide films according to the disclosure using the mixed solvents of Examples 1 to 3 were superior to surface characteristics of the polyimide films of Comparative Examples 1 to 3.

In addition, because the standard deviations of the thicknesses of the polyimide films according to the disclosure using the mixed solvents according to Examples 1 to 3 have lower values than those of the thicknesses of the polyimide films according to Comparative Examples 1 to 3, it was confirmed that the polyimide film according to the disclosure has superior thickness reliability.

It should be understood that embodiments described herein are merely for illustrative purposes, and various changes in form from the embodiments may be made by one of ordinary skill in the art. Therefore, the scope of the technical protection of the disclosure should be determined by the technical idea provided by the claims.

Because the composition and the polyimide film manufactured from the composition according to the disclosure do not use environmentally regulated solvents and have enhanced surface characteristics, high-quality electronic apparatuses and electronic devices may be provided by using the composition and the polyimide film manufactured from the composition.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A composition comprising:
a polymerizable component comprising a diamine compound-containing first component and a tetracarboxylic dianhydride-containing second component; and
a solvent,
wherein the solvent comprises a mixed solvent comprising two or more solvents, and
wherein the mixed solvent comprises an amide-based solvent and a sulfone-based solvent.

2. The composition of claim 1, wherein the amide-based solvent comprises N,N-dimethylpropionamide, 3-methoxy-N,N-dimethylpropionamide, N-methylpropionamide, N,N-diethylformamide, or any combination thereof.

3. The composition of claim 1,
wherein the amide-based solvent comprises a compound represented by Formula 1 below: 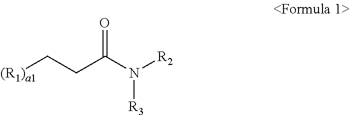
wherein in Formula 1,
R₁ to R₃ are each independently hydrogen, deuterium, —F, —Cl, —Br, —I, a hydroxyl group, a cyano group, a nitro group, a C₁-C₆₀ alkyl group unsubstituted or substituted with at least one R₁₀ₐ, a C₂-C₆₀ alkenyl group unsubstituted or substituted with at least one R₁₀ₐ, a C₂-C₆₀ alkynyl group unsubstituted or substituted with at least one R₁₀ₐ, a C₁-C₆₀ alkoxy group unsubstituted or substituted with at least one R₁₀ₐ, a C₁-C₆₀ alkylthio group unsubstituted or substituted with at least one R₁₀ₐ, a C₃-C₆₀ carbocyclic group unsubstituted or substituted with at least one R₁₀ₐ, a C₁-C₆₀ heterocyclic group unsubstituted or substituted with at least one R₁₀ₐ, a C₆-C₆₀ aryloxy group unsubstituted or substituted with at least one R₁₀ₐ, a C₆-C₆₀ arylthio group unsubstituted or substituted with at least one R₁₀ₐ, —C(Q₁)(Q₂)(Q₃), —Si(Q₁)(Q₂)(Q₃), —N(Q₁)(Q₂), —B(Q₁)(Q₂), —C(═O)(Q₁), —S(═O)₂(Q₁), or —P(═O)(Q₁)(Q₂), and
wherein a1 is an integer from 1 to 20,
wherein R₁₀ₐ is:
deuterium, —F, —Cl, —Br, —I, a hydroxyl group, a cyano group, or a nitro group;
a C₁-C₆₀ alkyl group, a C₂-C₆₀ alkenyl group, a C₂-C₆₀ alkynyl group, or a C₁-C₆₀ alkoxy group, each unsubstituted or substituted with deuterium, —F, —Cl, —Br, —I, a hydroxyl group, a cyano group, a nitro group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₁₁)(Q₁₂)(Q₁₃), —N(Q₁₁)(Q₁₂), —B(Q₁₁)(Q₁₂), —C(═O)(Q₁₁), —S(═O)₂(Q₁₁), —P(═O)(Q₁₁)(Q₁₂), or any combination thereof;
a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, or a C₂-C₆₀ heteroarylalkyl group, each unsubstituted or substituted with deuterium, —F, —Cl, —Br, —I, a hydroxyl group, a cyano group, a nitro group, a C₁-C₆₀ alkyl group, a C₂-C₆₀ alkenyl group, a C₂-C₆₀ alkynyl group, a C₁-C₆₀ alkoxy group, a C₃-C₆₀ carbocyclic group, a C₁-C₆₀ heterocyclic group, a C₆-C₆₀ aryloxy group, a C₆-C₆₀ arylthio group, a C₇-C₆₀ arylalkyl group, a C₂-C₆₀ heteroarylalkyl group, —Si(Q₂₁)(Q₂₂)(Q₂₃), —N(Q₂₁)(Q₂₂), —B(Q₂₁)(Q₂₂), —C(═O)(Q₂₁), —S(═O)₂(Q₂₁), —P(═O)(Q₂₁)(Q₂₂), or any combination thereof; or
—Si(Q₃₁)(Q₃₂)(Q₃₃), —N(Q₃₁)(Q₃₂), —B(Q₃₁)(Q₃₂), —C(═O)(Q₃₁), —S(═O)₂(Q₃₁), or —P(═O)(Q₃₁)(Q₃₂),
wherein Q₁ to Q₃, Q₁₁ to Q₁₃, Q₂₁ to Q₂₃, and Q₃₁ to Q₃₃ are each independently: hydrogen; deuterium; —F; —Cl; —Br; —I; a hydroxyl group; a cyano group; a nitro group; a C₁-C₆₀ alkyl group; a C₂-C₆₀ alkenyl group; a C₂-C₆₀ alkynyl group; a C₁-C₆₀ alkoxy group; a C₃-C₆₀ carbocyclic group or a C₁-C₆₀ heterocyclic group, each unsubstituted or substituted with deuterium, —F, a cyano group, a C₁-C₆₀ alkyl group, a C₁-C₆₀ alkoxy group, a phenyl group, a biphenyl group, or any combination thereof; a C₇-C₆₀ arylalkyl group; or a C₂-C₆₀ heteroarylalkyl group.

4. The composition of claim 1, wherein in Formula 1,
R₁ is hydrogen, deuterium, a C₁-C₆₀ alkyl group unsubstituted or substituted with at least one R₁₀ₐ, or a C₁-C₆₀ alkoxy group unsubstituted or substituted with at least one R₁₀ₐ, and
R₂ and R₃ are each independently hydrogen, deuterium, or a C₁-C₆₀ alkyl group unsubstituted or substituted with at least one R₁₀ₐ.

5. The composition of claim 1, wherein the sulfone-based solvent comprises tetramethylene sulfone, diphenyl sulfone, ethyl isopropyl sulfone, or any combination thereof.

6. The composition of claim 1, wherein a boiling point of the sulfone-based solvent is 200 °C or above.

7. The composition of claim 1, wherein the mixed solvent comprises the amide-based solvent and the sulfone-based solvent in a weight ratio of 1:99 to 99:1.

8. The composition of claim 1, wherein the composition further comprises a polymerization product of the polymerizable component.

9. The composition of claim 1, wherein the composition comprises the polymerizable component in an amount of 5 parts by weight to 30 parts by weight based on 100 parts by weight of the solvent.

10. The composition of claim 1, wherein the diamine compound-containing first component comprises at least two different diamine compounds.

11. The composition of claim 1, wherein the diamine compound-containing first component comprises 4,4-diaminodiphenyl ether, p-phenylenediamine, or any combination thereof.

12. The composition of claim 1, wherein the tetracarboxylic dianhydride-containing second component comprises biphenyl-tetracarboxylic dianhydride, benzophenone tetracarboxylic dianhydride, mesobutane-tetracarboxylic dianhydride, or any combination thereof.

13. The composition of claim 1, wherein a viscosity of the composition is about 1,000 cP to about 20,000 cP.

14. A polyimide film manufactured from the composition of claim 1.

15. The polyimide film of claim 14, wherein the polyimide film has a transmittance of 50% or more at a wavelength of 450 nm.

16. An electronic apparatus comprising the polyimide film of claim 14.

17. An electronic device comprising the polyimide film of claim 14.

18. The electronic device of claim 17, wherein the electronic device is one selected from a flat panel display, a curved display, a computer monitor, a medical monitor, a television, an advertising board, indoor and/or outdoor lighting and/or signaling light, a head-up display, a fully or partially transparent display, a flexible display, a rollable display, a foldable display, a stretchable display, a laser printer, a telephone, a mobile phone, a tablet, a phablet, a personal digital assistant (PDA), a wearable device, a laptop computer, a digital camera, a camcorder, a viewfinder, a microdisplay, a 3D display, a virtual reality or augmented reality display, a vehicle, a video wall comprising tiled multiple displays, a theater or stadium screen, a phototherapy device, and a signboard.

19. A method of preparing a polyimide film, the method comprising:
applying a composition to a carrier substrate; and
forming a polyimide film via imidization by heating the composition,
wherein the composition comprises:
a polymerizable component comprising a diamine compound-containing first component and a tetracarboxylic dianhydride-containing second component; and
a solvent,
wherein the solvent comprises a mixed solvent comprising two or more solvents, and
wherein the mixed solvent comprises an amide-based solvent and a sulfone-based solvent.

20. The method of claim 19, wherein the heating of the composition is performed at a temperature of about 50 °C to 500 °C.
